(19) United States
(12) Patent Application Publication
(10) Pub. No.: US 2007/0234318 A1
(43) Pub. Date: Oct. 4, 2007

(54) Method, system, and program product for generating source code for a function

(75) Inventors: Norman K. W. Seto, Richmond Hill (CA); John H. Green, Toronto (CA)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/397,585

(22) Filed: Apr. 4, 2006

(51) Int. Cl. G06F 9/45

(52) U.S. Cl. 717/140

(57) ABSTRACT

The present invention provides a method, system, and program product for generating source code for a function such as a Java method. Specifically, the present invention allows values passed as arguments to a method to be captured, and a property to be mapped to an output parameter such as a return bean. Attributes defined as part of a tag reference are interpreted by a code generator as being values that are set dynamically as a result of the arguments being passed to a method, or are interpreted as being a property to be assigned to an output parameter. Under the present invention, parameter information such as input parameter binding(s) and/or output binding(s) is provided using meta data language (e.g., Doclet) annotations. This parameter information is used by a code generator to generate the source code.

### BACKGROUND OF THE INVENTION

1. Field of the Invention

In general, the present invention relates to a method, system, and program product for generating source code for a function (e.g., a Java™ method) (Java and Java-based terms are trademarks of Sun Microsystems in the United States, other countries or both). Specifically, among other things, the present invention provides a way to capture values passed as arguments to a method, and to map a property to an output parameter such as a return bean.

2. Related Art

XDoclet, an attribute-oriented programming enablement, is an open source code generation engine that allows Java source code to be generated with meta information. In this environment, XDoclet tag references allow the capturing of static meta information as special JavaDoc tags. That is, a value can be specified that is used as part of code generation. Unfortunately, under current approaches, there are no tag references, no concept of tag references that allow the mapping of a method argument to be used as part of the code generation, and no provision to allow the mapping of a return parameter to be mapped to an output parameter such as a return bean. This is disadvantageous, for example, when it is desired to pass information that should not be visible, such as password information to a J2EE™ Connection Specification.

In view of the foregoing, there exists a need to overcome at least one of the deficiencies in the existing art.

### SUMMARY OF THE INVENTION

In general, the present invention provides a method, system, and program product for generating source code for a function, such as a Java method. Specifically, the present invention allows values passed as arguments to the function (e.g., method) to be captured, and a property to be mapped to an output parameter of the function such as a return bean. Attributes defined as part of a tag reference are interpreted by a code generator as being values that are set dynamically as a result of the arguments being passed to the function, or are interpreted as being a property to be assigned to the output parameter. Under the present invention, parameter information such as input parameter binding(s) and/or output binding(s) is provided using meta data language annotations in the form of specialized JavaDoc tags, which are herein referred to as Doclet annotations. This parameter information is used by a code generator to generate the source code. This mapping notion allows a user to specify sensitive information or dynamic information using the mechanism of argument passing, and still use a Doclet generation engine (Doclet, as opposed to XDoclet) to generate code without exposing the information. It also will allow a user to map properties specified via the Doclet tag notation to a Java bean, and have the code generation engine interpret it appropriately.

The J2C Doclet Tag Reference is a Java Doclet tag reference for the J2EE Java Connector Architecture specification client programming model. By using a J2C Doclet Tag Reference to annotate Java source code (e.g., via JavaDoc tags/annotations), a user can capture J2EE Java Connector Architecture meta information that could be consumed by a Doclet code generator to produce J2EE Java Connector Architecture client programming source code.

A first aspect of the present invention provides a method for generating source code for a function: obtaining parameter information for the function using meta data language annotations, the parameter information including at least one of an input parameter binding or an output binding; and generating the source code for the function using the parameter information.

A second aspect of the present invention provides a system for generating source code for a function: a system for obtaining parameter information for the function using meta data language annotations, the parameter information including at least one of an input parameter binding or an output binding; and a system for generating the source code for the function using the parameter information.

A third aspect of the present invention provides a program product stored on a computer readable medium for generating source code for a function, the computer readable medium comprising program code for causing a computer system to perform the following steps: obtaining parameter information for the function using meta data language annotations, the parameter information including at least one of an input parameter binding or an output binding; and generating the source code for the function using the parameter information.

A fourth aspect of the present invention provides a method for deploying an application for generating source code for a function: providing a computer infrastructure being operable to: obtain parameter information for the function using meta data language annotations, the parameter information including at least one of an input parameter binding or an output binding; and generate the source code for the function using the parameter information.

A fifth aspect of the present invention provides a method for deploying an application for generating source code for a function.

Therefore, the present invention provides a method, system, and program product for generating source code for a function.

### BRIEF DESCRIPTION OF THE DRAWING

These and other features of this invention will be more readily understood from the following detailed description of the various aspects of the invention taken in conjunction with the accompanying drawing that depicts an illustrative embodiment of the invention, in which:

FIG. 1 depicts a system for generating source code for a function according to the present invention.

It is noted that the drawing of the invention is not to scale. The drawing is intended to depict only typical aspects of the invention, and therefore should not be considered as limiting the scope of the invention.

### DETAILED DESCRIPTION OF THE INVENTION

For clarity purposes the Detailed Description of the Invention has the following sections:
I. General Description
   A. @j2c Class Level Tags/Annotations
   B. @j2c Method Level Tags/Annotations
   C. @j2c Class Level Tag/Annotation Usage
   D. @j2c Method Level Tag Usage
   E. Property Mapping Using Tags/Annotations
II. Computerized Implementation
   I. General Description

As indicated above, the present invention provides a method, system, and program product for generating source code for a function, such as a Java method. Specifically, the present invention allows values passed as arguments to the function to be captured, and a property to be mapped to an output parameter of the function such as a return bean. Attributes defined as part of a tag/annotation reference are interpreted by a code generator as being values that are set dynamically as a result of the arguments being passed to the function, or are interpreted as being a property to be assigned to an output parameter. Under the present invention, parameter information such as input parameter binding(s) and/or output binding(s) is provided using meta data language (e.g., Doclet) annotations. This parameter information is used by a code generator to generate the source code.

This mapping notion allows a user to specify sensitive information or dynamic information using the mechanism of argument passing, and still use the Doclet generation engine to generate code without exposing the information. It also will allow a user to map properties specified via the Doclet tag notation to a program module (e.g., Java bean), and have the code generation engine interpret it appropriately. It should be understood in advance that while the present invention is typically implemented using or J2C Doclet tags/annotations to specify the parameter information, any meta data language tags/annotations could be utilized.

Before the code generation functions of the present invention are depicted and described in greater detail, a description of J2C Doclet tag/annotations and their usage under the present invention will first be given:

A. @j2c Class Level Tags/Annotations

@j2c.connectionFactory
@j2c.managedConnectionFactory
@j2c.managedConnectionFactory-property
@j2c.connectionSpec
@j2c.connectionSpec-property
@j2c.interactionSpec
   B. @j2c Method Level Tags/Annotations
@j2c.connectionSpec
@j2c.connectionSpec-property
@j2c.interactionSpec
@j2c.interactionSpec-property
@j2c.interactionSpec-returnProperty
   C. @j2c Class Level Tag/Annotation Usage
@j2c.connectionFactory (0..1)

The j2c.connectionFactory tag/annotation provides information of the Connection Factory that will be used to create a connection.

| Parameter | Type | Description | Required |
|---|---|---|---|
| jndi-name | String | The JNDI name used to look up the | Yes |
| | | connection factory | |

@j2c.managedConnectionFactory (0..1)

The j2c.managedConnectionFactory tag provides information of the Managed Connection Factory that will be used to create the connection in a non-managed scenario.

| Parameter | Type | Description | Required |
|---|---|---|---|
| class | String | The name of the class to be used | Yes |

@j2c.managedConnectionFactory-property (0..n)

The j2c.managedConnectionFactory-property tag provides information of the property of the Managed Connection Factory.

| Parameter | Type | Description | Required |
|---|---|---|---|
| name | String | The name of the property | Yes |
| value | String | The value of the property defined | Yes |
| | | statically | |

@j2c.connectionSpec (0..1)

The j2c.connectionSpec tag provides information of the Connection Spec that will be used.

| Parameter | Type | Description | Required |
|---|---|---|---|
| class | String | The name of the class to be used | Yes |

@j2c.connectionSpec-property (0..n)

The j2c.connectionSpec-property tag provides information of the property of the Connection Spec.

| Parameter | Type | Description | Required |
|---|---|---|---|
| name | String | The name of the property | Yes |
| value | String | The value of the property defined | Yes |
| | | statically | |

@j2c.interactionSpec (0..1)

The j2c.interactionSpec tag provides information of the default Interaction Spec that will be used.

| Parameter | Type | Description | Required |
|---|---|---|---|
| class | String | The name of the class to be used | Yes |

D. @j2c Method Level Tag Usage
@j2c.connectionSpec (0..1)

The j2c.connectionSpec tag provides information of the Connection Spec that will be used for the method.

| Parameter | Type | Description | Required |
|---|---|---|---|
| class | String | The name of the class to be used | Yes |

@j2c.connectionSpec-property (0..n)

The j2c.connectionSpec-property tag provides information of the property of the Connection Spec. The argument binding represents an input parameter binding that can be provided under the present invention.

| Parameter | Type | Description | Required |
|---|---|---|---|
| name | String | The name of the property | Yes |
| value | String | The value of the property defined | No |
| | | statically | |
| argument- | String | The value of the method argument. | No |
| binding | | This is used if the value of the | |
| | | property would be passed as a | |
| | | parameter to the method. | |

@j2c.interactionSpec (0..1)

The j2c.interactionSpec tag provides information of the Interaction Spec that will be used for the method.

| Parameter | Type | Description | Required |
|---|---|---|---|
| class | String | The name of the class to be used | Yes |

@j2c.interactionSpec-property (0..n)

The j2c.interactionSpec-property tag provides information of the property of the Interaction Spec. As indicated above, the argumentbinding represents an input parameter binding that can be provided under the present invention.

| Parameter | Type | Description | Required |
|---|---|---|---|
| name | String | The name of the property | Yes |
| value | String | The value of the property defined | No |
| | | statically | |
| argument- | String | The value of the method argument. | No |
| binding | | This is used if the value of the | |
| | | property would be passed as a | |
| | | parameter to the method. | |

@j2c.interactionSpec-returnProperty (0..n)

The j2c.interactionSpec-returnProperty tag provides information of the property of the Interaction Spec that will be returned after the method call. The outputbinding in the table represent an output binding that can be provided under the present invention.

| Parameter | Type | Description | Required |
|---|---|---|---|
| name | String | The name of the property | Yes |
| outputbinding | String | The Java Bean property of the | Yes |
| | | return object that represents | |
| | | the property value. | |

E. Property Mapping Using Tags/Annotations

As part of the J2C Doclet Tag/Annotation Reference, there is a tag/annotation to capture the name value pair of a property. To enable a value to be specified dynamically, an additional attribute is used, which maps to an argument that is being passed to the method. A code generator would interpret this appropriately and would generate code using the argument that it is passed. An example of an input parameter being mapped to a property to be used to initialize that property in accordance with the present invention is shown in the following:

public class CustomerInfoBinding {

/**
* @j2c.connectionSpec class=“com.ibm.connector2.cics.ECIConnectionSpec”
* @j2c.connectionSpec-property name=“userName” value=“sysad”
* @j2c.connectionSpec-property name=“password” argumentBinding=“pw”
* @j2c.interactionSpec
class=“com.ibm.connector2.cics.ECIInteractionSpec”
* @j2c.interactionSpec-property name=“functionName” value=“TADERC99”
* @generated
*/
public Taderc99 getCustomer(Taderc99 arg, String pw) throws

javax.resource.ResourceException {

return null;

}

}

After specifying these Doclet tags/annotations (in particular:

@j2c.connectionSpec-property name=“password” argumentBinding=“pw”), a code generator could produce code similar to the following:

/**
* @j2c.connectionSpec class=“com.ibm.connector2.cics.ECIConnectionSpec”
* @j2c.connectionSpec-property name=“userName” value=“sysad”
* @j2c.connectionSpec-property name=“password” argumentBinding=“pw”
* @j2c.interactionSpec

class=“com.ibm.connector2.cics.ECIInteractionSpec”

* @j2c.interactionSpec-property name=“functionName” value=“TADERC99”
* @generated
*/

public Taderc99 getCustomer(Taderc99 arg, String pw) throws
javax.resource.ResourceException {

ConnectionSpec cs = getConnectionSpec( );
if(cs = = null) {

cs = new com.ibm.connector2.cics.ECIConnectionSpec( );
((com.ibm.connector2.cics.ECIConnectionSpec)

cs).setUserName(“sysad”);

((com.ibm.connector2.cics.ECIConnectionSpec)

cs).setPassword(pw);

}
InteractionSpec is = getInteractionSpec( );
if(is = = null) {

is = new com.ibm.connector2.cics.ECIInteractionSpec( );
((com.ibm.connector2.cics.ECIInteractionSpec)

is).setFunctionName(“TADERC99”);

}
Object o = invoke(cs, is, arg, Taderc99.class);
return (Taderc99) o;

}

Also as part of the J2C Doclet Tag/Annotation Reference, the present invention provides a tag/annotation to capture the property that is to be mapped to a property of the output bean. A code generator would interpret this appropriately and map the specified property into the output bean. An example of this is the following:

public class CustomerInfoBinding {

/**
* @j2c.connectionSpec class=“com.ibm.connector2.cics.ECIConnectionSpec.”
* @j2c.connectionSpec-property name=“userName” value=“sysad”
* @j2c.connectionSpec-property name=“password” argumentBinding=“pw”
* @j2c.interactionSpec

class=“com.ibm.connector2.cics.ECIInteractionSpec”

| | * @j2c.interactionSpec-property name=“functionName” value=“TADERC99” |
|---|---|
| | * @j2c.interactionSpec-returnProperty name=“functionName” |
| | outputBinding=“function” |
| | * @generated |
| * | / |
| | public Taderc99Bean getCustomer(Taderc99 arg, String pw) throws |

javax.resource.ResourceException {

return null;

}

}

After specifying these Doclet tags (in particular:

@j2c.interactionSpec-returnProperty name=“functionName” outputBinding=“function”), a code generator could produce source code similar to the following:

/**
* @j2c.connectionSpec class=“com.ibm.connector2.cics.ECIConnectionSpec”
* @j2c.connectionSpec-property name=“userName” value=“sysad”
* @j2c.connectionSpec-property name=“password” argumentBinding=“pw”
* @j2c.interactionSpec

class=“com.ibm.connector2.cics.ECIInteractionSpec”

* @j2c.interactionSpec-property name=“functionName” value=“TADERC99”
* @j2c.interactionSpec-returnProperty name=“functionName”

outputBinding=“function”

* @generated
*/
public Taderc99Bean getCustomer(Taderc99 arg, String pw) throws

javax.resource.ResourceException {

ConnectionSpec cs = getConnectionSpec( );
if (cs = = null) {

cs = new com.ibm.connector2.cics.ECIConnectionSpec( );
((com.ibm.connector2.cics.ECIConnectionSpec)

cs).setUserName(“sysad”);

((com.ibm.connector2.cics.ECIConnectionSpec)

cs).setPassword(pw);

}
InteractionSpec is = getInteractionSpec( );
if (is = = null) {

is = new com.ibm.connector2.cics.ECIInteractionSpec( );
((com.ibm.connector2.cics.ECIInteractionSpec)

is).setFunctionName(“TADERC99”);

}
Object o = invoke(cs, is, arg, Taderc99.class);
Taderc99Bean bean = new Taderc99Bean( );
bean.setTaderc99((Taderc99)o);
bean.setFunction(((com.ibm.connector2.cics.ECIInteractionSpec)

is).getFunctionName( ));

return bean;

}

As can be seen from the two above code generator-based source code segments, the present invention allows properties to be mapped to input or output parameters using meta data language tags/annotations and source code for corresponding functions (e.g., Java methods) to be generated.

In addition to returning a Taderc99 object, the present invention allows values already assigned to another bean (e.g., interaction spec) to be returned. The present invention provides a notion via the tag definition (interpreted by the code generator), which allows a user to specify what return value(s) are desired and to which variable it should be assigned.

As such, in the tag/annotation: * @j2c.interactionSpec-returnProperty name=“functionName” outputBinding=“function”
the name attribute in the tag/annotation represents the Java attribute “funtionName” belonging to the J2C interaction spec. (the class was assigned earlier with the tag/annotation (@j2c.interactionSpec class=“com.ibm.connector2.cics.ECIInteractionSpec”)
the outputBinding attribute represents the name of the Java attribute in the return type (Taderc99Bean) to which it would be assigned

Shown below is a sample of the Taderc99Bean.java package test;

public class Taderc99Bean {

public Taderc99 abc;
public String function;
public Taderc99 getAbc( ) {
return abc;
}
public void setAbc(Taderc99 abc) {

this.abc = abc;

}
public String getFunction( ) {

return function;

}
public void setFunction(String function) {

this.function = function;

}

}

Under the present invention, the code generator will generate the lines to provide this function.

| | |
|---|---|
| Taderc99Bean bean = new Taderc99Bean( ); | // Generate the return type |
| bean.setTaderc99((Taderc99)o); | // assign the Taderc99 to the |

wrapper object (done by checking which type in the

// Taderc99Bean is typed to

Taderc99
bean.setFunction(((com.ibm.connector2.cics.ECIInteractionSpec)is).getFunctionName( ));

//Gets the functionName from the interaction spec
// bean and assigns it to the wrapper object attribute
// indicated by the value in outputBinding

II. Computerized Implementation

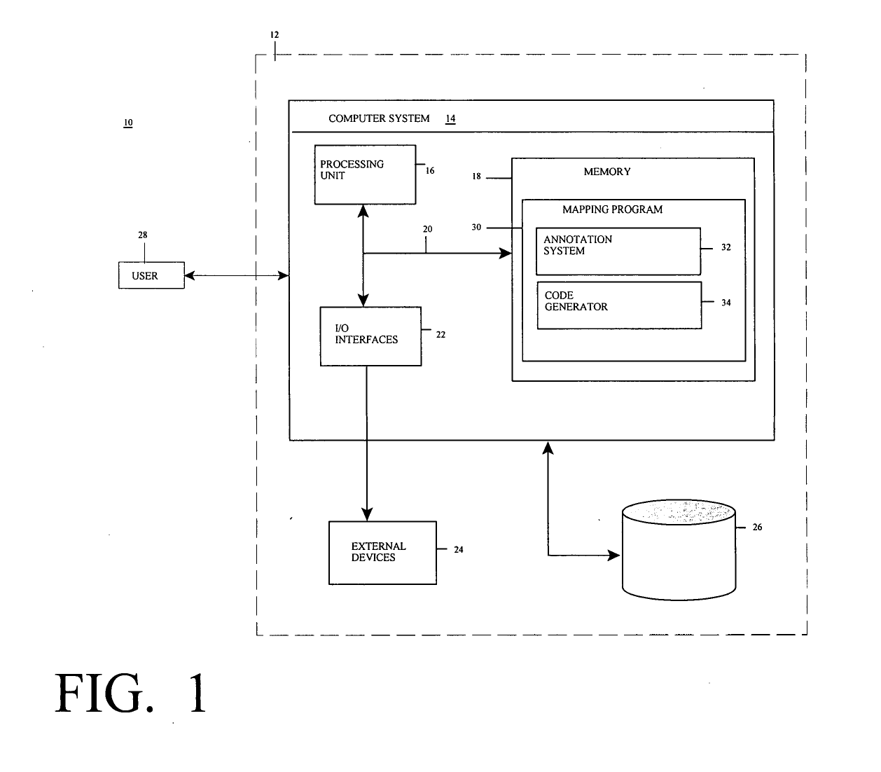

Referring now to FIG. 1, a diagram of a computerized implementation 10 of the present invention is shown. As depicted, implementation 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of implementation 10 could be deployed, managed, serviced, etc. by a service provider who offers to generate source code for a function according to the present invention.

As shown, computer system 14 includes a processing unit 16, a memory 18, a bus 20, and input/output (I/O) interfaces 22. Further, computer system 14 is shown in communication with external I/O devices/resources 24 and storage system 26. In general, processing unit 16 executes computer program code, such as mapping program 30, which is stored in memory 18 and/or storage system 26. While executing computer program code, processing unit 16 can read and/or write data to/from memory 18, storage system 26, and/or I/O interfaces 22. Bus 20 provides a communication link between each of the components in computer system 14. External devices 24 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 16 may comprise a single processing unit, or be distributed across one or more processing units in one or more locations, e.g., on a client and server. Similarly, memory 18 and/or storage system 26 can comprise any combination of various types of data storage and/or transmission media that reside at one or more physical locations. Further, I/O interfaces 22 can comprise any system for exchanging information with one or more external devices 24. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 24 (e.g., a display) and/or storage system(s) 26 could be contained within computer system 14, not externally as shown.

Storage system 26 can be any type of system (e.g., a database) capable of providing storage for information under the present invention such as annotations, generated source code, components such as Java beans etc. To this extent, storage system 26 could include one or more storage devices, such as a magnetic disk drive or an optical disk drive. In another embodiment, storage system 26 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 18 of computer system 14 is mapping program 30, which includes annotation system 32 and code generator 34. It should be understood that representation of mapping program 30 is intended only to illustrate one possible way of providing the functionality described herein. As such, the functionality described herein could be represented by a different configuration of systems (e.g., the functions provided by the systems of mapping program 30 could be combined into fewer systems or further separated into additional systems). In addition, although the functionality of the present invention is described herein as being carried out by a single program (e.g., mapping program 30), this need not be the case. For example, multiple different programs could be implemented to achieve the desired function (e.g., mapping program 30 could leverage existing technology in providing its desired results).

Regardless, annotation system 32 will be leveraged by user 28 to provide parameter information for a function (e.g., Java method) for which source code is desired to be generated. Specifically, user 28 will define meta data language tags/annotations to provide parameter information such an input parameter binding and/or an output binding. This allows the mapping of a method/function argument, as well as the mapping of a return parameter to an output parameter such as a return bean. Specifically, the use of the tags/annotations as described above allows a Java method to be “hooked into” as an input or an output. In addition, the mappings done via annotation system 32 allow values already assigned to another bean to be returned. This is done by using a wrapper object, which would hold the objects. Specifically, using annotation system 32, user 28 will identify the return value that is desired to be returned, and to which variable it should be assigned.

Once the annotations have been defined, code generator 34 will use the same to generate source code (e.g., Java source code) based thereon. Specifically, source code generator 34 can be a Doclet code generator that references a set of input parameters for a function (e.g., a Java method) using the input parameter bindings provided via the annotations, and then generates source code in initialize a set of properties using the set of input parameters. Moreover, code generator 34 can reference a set of output parameters for the function using the output bindings provided via the annotations, and then generate source code to initialize another set of properties using the set of output parameters. That is, source code generator 34 will generate source code to map an output of the function to a component such as a Java bean using the output binding. Still further, code generator 34 can generate source code for a desired return value as assigned to a particular variable (e.g., the “wrapper object” function of the present invention).

While shown and described herein as a method and system generating source code for a function, it is understood that the invention further provides various alternative embodiments. For example, in one embodiment, the invention provides a computer-readable/useable medium that includes computer program code to enable a computer infrastructure to generate source code for a function. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 18 (FIG. 1) and/or storage system 26 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to generate source code for a function. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for generating source code for a function. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for generating source code for a function, comprising the steps of:
obtaining parameter information for the function using meta data language annotations, the parameter information including at least one of an input parameter binding or an output binding; and
generating the source code for the function using the parameter information.

2. The method of claim 1, the source code being Java code.

3. The method of claim 1, the generating comprising:
referencing a set of input parameters for the function using the input parameter binding; and
generating source code to initialize a set of properties using the set of input parameters.

4. The method of claim 1, the generating comprising mapping a property of the function to an output parameter using the output binding.

5. The method of claim 1, further comprising defining the meta data language annotations.

6. The method of claim 1, the meta data language annotations being JavaDoc tags.

7. A system for generating source code for a function, comprising:
a system for obtaining parameter information for the function using meta data language annotations, the parameter information including at least one of an input parameter binding or an output binding; and
a system for generating the source code for the function using the parameter information.

8. The system of claim 7, the source code being Java code.

9. The system of claim 7, the system for generating comprising:
a system for referencing a set of input parameters for the function using the input parameter binding; and
a system for generating source code to initialize a set of properties using the set of input parameters.

10. The system of claim 7, the system for generating further comprising a system for generating source code to map a property of the function to an output parameter using the output binding.

11. The system of claim 7, the meta data language annotations being JavaDoc tags.

12. A program product stored on a computer readable medium for generating source code for a function, the computer readable medium comprising program code for causing a computer system to perform the following steps:
obtaining parameter information for the function using meta data language annotations, the parameter information including at least one of an input parameter binding or an output binding; and
generating the source code for the function using the parameter information.

13. The program product of claim 12, the source code being Java code.

14. The program product of claim 12, the computer readable medium further comprising program code for causing the computer system to perform the following steps:
referencing a set of input parameters for the function using the input parameter binding; and
generating source code to initialize a set of properties using the set of input parameters.

15. The program product of claim 12, the computer readable medium further comprising program code for causing the computer system to perform following step: mapping a property of the function to an output parameter using the output binding.

16. The program product of claim 12, the meta data language annotations being JavaDoc tags.

17. A method for deploying an application for generating source code for a function:
providing a computer infrastructure being operable to:
obtain parameter information for the function using meta data language annotations, the parameter information including at least one of an input parameter binding or an output binding; and
generate the source code for the function using the parameter information.

18. The method of claim 17, the computer infrastructure being further operable to:
reference a set of input parameters for the function using the input parameter binding; and
generate source code to initialize a set of properties using the set of input parameters.

19. The method of claim 17, the computer infrastructure being further operable to mapping a property of the function to an output parameter using the output binding.

20. The method of claim 17, the meta data language annotations being JavaDoc tags.
